(19) United States
(12) Patent Application Publication
(10) Pub. No.: US 2026/0290903 A1
(43) Pub. Date: Sep. 24, 2026

(54) HERMETICALLY SEALED SOLID-STATE BATTERY MODULE WITH ISOSTATIC PRESSURIZATION AND METHODS OF MANUFACTURE AND OPERATION

(71) Applicant: Ampcera Inc., Tucson, AZ (US)

(72) Inventors: Yu-Ting Chen, Tucson, AZ (US); Hui Du, Tucson, AZ (US); Eongyu Yi, Tucson, AZ (US); James Emery Brown, Tucson, AZ (US)

(73) Assignee: Ampcera Inc., Tucson, AZ (US)

(21) Appl. No.: 19/576,161

(22) Filed: Mar. 24, 2026

Related U.S. Application Data
(60) Provisional application No. 63/776,461, filed on Mar. 24, 2025.

(51) Int. Cl. H01M 10/058; H01M 10/0562; H01M 50/169; H01M 50/171; H01M 50/172; H01M 50/184; H01M 50/474; H01M 50/477; H01M 50/486

(52) U.S. Cl. CPC H01M 10/058; H01M 10/0562; H01M 50/169; H01M 50/171; H01M 50/172; H01M 50/184; H01M 50/474; H01M 50/477; H01M 50/486

(57) ABSTRACT

A solid-state battery module comprises a hermetically sealed enclosure configured to prevent the ingress and egress of gases, ensuring a controlled internal environment. Within the hermetically sealed enclosure, one or more solid-state battery cells are positioned as energy storage components. A pressurizing material is disposed within the enclosure and is configured to apply isostatic pressure to the solid-state battery cells, maintaining stable interfacial contact, enhancing electrochemical performance, and mitigating mechanical stress to improve the reliability and longevity of the battery module.

### PRIORITY

This application claims the benefit of U.S. Provisional Patent Application No. 63/776,461, filed Mar. 24, 2025, the entire contents of which are incorporated herein by reference.

### FIELD

The present disclosure relates to the field of solid-state battery technology, specifically to hermetically sealed battery modules that incorporate isostatic pressurization to enhance battery performance, durability, and reliability. The disclosure further relates to methods for manufacturing and operating such battery modules, including the integration of pressurizing materials, activation mechanisms, and electrical feedthroughs to maintain controlled internal pressure. The described battery module is applicable to electric vehicles, aerospace systems, grid storage, consumer electronics, and other energy storage applications that benefit from enhanced mechanical stability and environmental protection.

### BACKGROUND

Solid-state batteries (SSBs) have been developed as an alternative to conventional lithium-ion batteries, offering advantages such as enhanced safety, energy density, and thermal stability. Unlike traditional lithium-ion batteries, which rely on liquid electrolytes, SSBs utilize solid electrolytes to facilitate ion transport between the electrodes. The absence of liquid components eliminates the risks of electrolyte leakage, reduces flammability concerns, and allows for the use of high-energy electrode materials, such as lithium metal anodes. However, the successful implementation of SSBs has required the development of methods to address challenges associated with interfacial resistance, interfacial contact, mechanical stability, and long-term cycling performance.

Prior approaches have recognized the need to apply pressure to solid-state battery cells to enhance electrochemical performance. Maintaining stable interfacial contact between the solid electrolyte and the electrodes is essential for efficient ion conduction. Any gaps, voids, or delamination at these interfaces can lead to increased resistance, uneven current distribution, and performance degradation over repeated charge-discharge cycles. Various techniques have been developed to apply pressure to solid-state battery cells, including external compression mechanisms such as spring-loaded structures, mechanical clamps, and external pressure plates. These methods aim to sustain interfacial contact during operation, improving ionic conductivity and reducing cell degradation over time. However, they require additional structural components and increase the complexity of battery pack integration, especially in applications where space and weight are critical factors.

Battery enclosures have been developed to provide mechanical protection and environmental sealing. Hermetically sealed enclosures have been employed in battery systems to protect internal components from contaminants such as moisture, oxygen, and particulates, which can degrade battery performance. Various sealing techniques, including welding, brazing, adhesive bonding, and gasketed interfaces, have been utilized to create airtight battery enclosures. These enclosures serve to isolate battery cells from external environmental conditions, preventing exposure to humidity and other atmospheric factors that could compromise performance and longevity. Some battery designs incorporate electrical feedthroughs that extend through a sealed enclosure, allowing for external connectivity while maintaining the integrity of the internal environment.

Pressurization techniques have been explored to maintain structural integrity and improve battery performance. Previous designs have incorporated mechanical compression methods or external pressure chambers to exert force on battery cells, ensuring proper contact between components. While these methods can be effective, they often introduce additional weight, volume, and complexity to battery modules. The ability to achieve uniform, self-sustaining isostatic pressure within a hermetically sealed battery module has remained a challenge, particularly in applications requiring compact, lightweight, and durable energy storage solutions.

Accordingly, those skilled in the art continue with research and development in the field of solid-state battery technology.

### SUMMARY

In one embodiment, a solid-state battery module comprises a hermetically sealed enclosure configured to prevent the ingress and egress of gases, ensuring a controlled internal environment. Within the hermetically sealed enclosure, one or more solid-state battery cells are positioned as energy storage components. A pressurizing material is disposed within the enclosure and is configured to apply isostatic pressure to the solid-state battery cells, maintaining stable interfacial contact, enhancing electrochemical performance, and mitigating mechanical stress to improve the reliability and longevity of the battery module.

In another embodiment, a method for manufacturing a solid-state battery module comprises placing one or more solid-state battery cells within an enclosure, arranging them in a manner that optimizes electrical and mechanical performance. A pressurizing material is then positioned within the enclosure, which may be incorporated in a manner that ensures uniform pressure application upon activation or expansion. The enclosure is then hermetically sealed, preventing gas ingress and egress while maintaining the necessary internal pressure conditions. This method enables the fabrication of a hermetically sealed solid-state battery module capable of stable operation, environmental protection, and sustained mechanical compression of the battery cells.

In yet another embodiment, a method for operating a solid-state battery module comprises providing a hermetically sealed solid-state battery module containing one or more solid-state battery cells and a pressurizing material within a hermetically sealed enclosure. During operation, the pressurizing material is activated, which may occur through thermal, chemical, electrical, or mechanical means, to apply isostatic pressure to the battery cells. The applied pressure maintains stable interfacial contact, mitigates structural degradation, and enhances the electrochemical efficiency of the battery cells, ensuring reliable operation over the lifespan of the module.

Other embodiments of the disclosed solid-state battery module, methods of manufacture, and methods of operation will become apparent from the following detailed description, the accompanying drawings, and the appended claims.

### BRIEF DESCRIPTION OF THE DRAWINGS

The accompanying drawings, which are incorporated herein and form a part of the specification, illustrate various embodiments of the present disclosure and, together with the description, serve to explain the principles of the disclosure.

FIG. 1 is a schematic cross-sectional view of an example hermetically sealed solid-state battery module, illustrating an enclosure, one or more solid-state battery cells, a pressurizing material, an internal free volume, and electrical feedthroughs.

### DETAILED DESCRIPTION

A solid-state battery module comprising a hermetically sealed enclosure configured to maintain a controlled internal environment by preventing the ingress and egress of gases. Within the sealed enclosure, one or more solid-state battery cells are positioned, and a pressurizing material is included to apply isostatic pressure to the battery cells. This pressurization helps maintain stable interfacial contact, mitigates mechanical stress, and enhances the electrochemical performance and longevity of the battery cells.

A method for manufacturing the solid-state battery module includes assembling one or more solid-state battery cells within an enclosure, introducing a pressurizing material, and hermetically sealing the enclosure to form a controlled, pressurized environment. The pressurizing material may be positioned in various ways and can be configured to activate under predetermined conditions.

A method for operating the solid-state battery module involves providing a hermetically sealed enclosure containing solid-state battery cells and a pressurizing material. During operation, the pressurizing material applies isostatic pressure, either passively or through activation via thermal, chemical, electrical, or mechanical stimuli, to maintain consistent pressure conditions throughout the module's lifespan.

In some embodiments, the hermetically sealed enclosure comprises a housing and a cover joined together at a sealing interface to form the hermetically sealed enclosure. The sealing interface may be formed by welding, brazing, bonding, or by a gasketed seal. The housing and cover may be formed from metallic materials, polymeric materials, composite materials, or combinations thereof. The sealing interface may extend along a perimeter of the enclosure and may be configured to maintain the hermetic integrity of the enclosure during operation of the battery module.

In certain embodiments, the enclosure defines an internal free volume that is configured to receive a pressurizing gas generated by the pressurizing material. The internal free volume may be distributed around the one or more solid-state battery cells and may permit the pressurizing gas to propagate throughout the enclosure to apply substantially uniform isostatic pressure to the battery cells.

In some embodiments, the pressurizing material comprises a gas-generating compound configured to generate a pressurizing gas after the enclosure has been hermetically sealed. The gas-generating compound may comprise, for example, sodium azide, ammonium bicarbonate, calcium carbonate, hydrides, peroxides, diazo compounds, or combinations thereof. The gas-generating compound may be configured to decompose or react to generate gas under predetermined activation conditions.

In other embodiments, the pressurizing material comprises an expandable material configured to expand within the enclosure after sealing of the enclosure. For example, the expandable material may comprise a foamable polymer, an elastomeric expansion material, an expandable composite material, or other materials capable of increasing in volume to generate pressure within the enclosure.

In some embodiments, the solid-state battery module further comprises at least one electrical feedthrough extending through the hermetically sealed enclosure and electrically coupled to the one or more solid-state battery cells. The electrical feedthrough may be configured to allow electrical connection between the battery cells within the enclosure and external electrical components while maintaining the hermetic integrity of the enclosure.

In certain embodiments, the pressurizing material may be activated by one or more activation mechanisms including thermal activation, electrical activation, chemical activation, or mechanical activation. Activation of the pressurizing material may cause the generation of a pressurizing gas or the expansion of the pressurizing material within the enclosure, thereby producing isostatic pressure within the enclosure that is applied to the one or more solid-state battery cells.

During operation of the solid-state battery module, the pressurizing gas or expanded material may occupy at least a portion of the internal free volume of the enclosure and may distribute pressure substantially uniformly throughout the enclosure. This pressure may help maintain interfacial contact within the solid-state battery cells, reduce delamination or mechanical degradation, and enhance electrochemical stability during repeated charge and discharge cycles.

### Solid State Battery Module Overview

The solid-state battery module integrates a hermetically sealed enclosure, one or more solid-state battery cells, pressurizing material, and electrical connections to enhance battery performance, longevity, and operational stability. The module is designed to address key challenges in solid-state battery systems, including maintaining stable interfacial contact, mitigating mechanical stress, ensuring environmental protection, and optimizing energy transfer.

A primary function of the module is the application of isostatic pressure to the solid-state battery cells. These cells require sustained mechanical compression to maintain efficient ionic conduction and minimize resistance at material interfaces. The pressurizing material, contained within the sealed enclosure, ensures uniform pressure application to prevent interfacial degradation caused by delamination, void formation, or microcracking. By counteracting volume fluctuations during charge-discharge cycles, the pressurizing material stabilizes cell structure and improves overall cycle life. The material may be selected based on its ability to provide consistent pressure without excessive buildup or degradation over time.

The hermetically sealed enclosure is engineered to maintain a stable pressurized environment, preventing gas ingress and egress while sustaining the necessary pressure on the battery cells. The enclosure is typically constructed from multiple sections, such as a main housing and a cover, which are assembled and sealed through welding, brazing, bonding, or gasketed interfaces. Its structure accommodates mechanical stresses, thermal expansion, and environmental factors to ensure long-term performance. Internally, reinforcements, ribbed sections, or support structures may be incorporated to maintain uniform pressure distribution and structural integrity.

The electrical connections within the module provide conductive pathways for energy transfer while extending through the enclosure via electrical feedthroughs. These feedthroughs allow internal interconnections—such as busbars, tab welds, wire bonds, or flexible conductors—to interface with external circuits. The electrical configuration is designed to minimize resistance, manage thermal effects, and ensure mechanical stability. The interconnections may be arranged in serial, parallel, or hybrid configurations depending on voltage and capacity requirements. Reinforced interfaces, insulation barriers, and heat management features may be integrated to enhance durability and efficiency under various operational conditions.

The module may also incorporate additional features to enhance functionality, safety, and reliability. These may include internal sensors for monitoring pressure, temperature, and state-of-charge, as well as thermal management systems to regulate operational conditions. In some designs, the module may include modular access features to facilitate assembly and serviceability while maintaining overall structural integrity.

By integrating controlled pressurization, a sealed protective enclosure, and efficient electrical pathways, the solid-state battery module supports high-performance applications that require enhanced safety, longevity, and energy efficiency. Its design is well-suited for use in electric vehicles, aerospace systems, grid storage, and other advanced energy storage solutions where mechanical stability and environmental protection are critical to long-term operation.

### Hermetically Sealed Enclosure

The hermetically sealed enclosure maintains a controlled internal environment, applying consistent isostatic pressure to the battery cells while preventing gas ingress and egress. By preserving a stable pressurized environment, the enclosure enhances battery performance, mitigates interfacial degradation, and protects internal components from contaminants such as moisture, oxygen, and particulates. Ensuring a properly sealed and pressurized interior helps sustain electrochemical efficiency and structural integrity throughout the operational lifespan of the battery module.

The enclosure is typically formed from multiple structural sections that are assembled and sealed to create an airtight interior. These sections may include a main housing and a cover, which are joined using welding, brazing, bonding, or gasketed sealing mechanisms. The interface between these sections is designed to form a secure and durable seal capable of withstanding internal and external mechanical stresses without compromising pressure retention. While this description focuses on multi-part enclosures, the design is not strictly limited to such configurations, allowing for variations based on manufacturing and application requirements. Some enclosures may incorporate access features that facilitate assembly while maintaining long-term hermeticity.

Sealing interfaces are designed to ensure a gas-tight and pressure-retaining structure. Precision-machined sealing surfaces, welded joints, bonded interfaces, or gasketed connections can establish a hermetic barrier that prevents pressure loss and protects against environmental exposure. Welded or brazed joints can provide a permanent seal that is highly resistant to mechanical degradation and thermal cycling. Bonded interfaces can utilize adhesives or other sealing compounds to create a durable connection that can accommodate slight flexing or movement. Gasketed connections, commonly used in enclosures requiring modular access, can rely on compressible materials to maintain an airtight seal under variable conditions. Some designs incorporate redundant sealing layers to improve reliability and minimize the risk of leakage over time, ensuring continued function in applications that demand extreme durability and longevity.

Internally, structural features can be included to maintain uniform pressure distribution and prevent mechanical stress. Ribbed sections reinforce the enclosure walls, helping to prevent flexing or deformation under pressure. Internal supports provide additional stability by evenly distributing applied forces, reducing localized stress points that could compromise the enclosure's integrity. Containment features secure the pressurizing material, preventing movement or displacement that could lead to uneven pressure application. These internal elements ensure that the pressurizing material remains in optimal contact with the battery cells, maintaining a consistent mechanical load to prevent delamination, void formation, or other interfacial degradation effects.

The enclosure can be engineered to sustain the necessary internal pressure over extended periods while withstanding environmental fluctuations such as temperature changes, mechanical vibrations, and external impacts. The structural design, combined with sealing mechanisms, can ensure that the enclosure continues to perform reliably, maintaining a controlled internal environment essential for the stable and efficient operation of the solid-state battery module.

### Solid State Battery Cells

The hermetically sealed solid-state battery module includes one or more solid-state battery cells that function as the primary energy storage and delivery components. These cells utilize a solid electrolyte and may be configured in various ways depending on performance, integration, and application requirements.

Each solid-state battery cell may include a cathode, a solid electrolyte, and a current collector. An anode may be present or omitted, depending on the specific design. In some configurations, lithium is plated onto the current collector during charging rather than being pre-formed as a distinct anode layer. In other configurations, the anode may comprise a carbon allotrope or a Group 14 element such as silicon, germanium, or tin. The cathode may include lithium metal oxides, sulfides, phosphates, or other active materials. The solid electrolyte serves as both an ion conductor and a separator and may be composed of ceramic, polymer, sulfide-based, or other solid-state materials. The anode, cathode, and solid electrolyte separating layer may include a binding polymer. Moreover, the anode and cathode may comprise an electrically conductive additive to enhance power rates. Current collectors, which facilitate electron transport, may be formed from conductive materials.

The structure of the battery cells may be designed to accommodate mechanical stresses and environmental conditions associated with their operation. The cells may incorporate design features that optimize energy storage, cycle life, and reliability. Mechanical reinforcements or flexible layers may be included to enhance durability and accommodate pressure variations within the module.

The arrangement of the battery cells may vary based on module design. Cells may be stacked, rolled, or otherwise structured to achieve the desired form factor, voltage, and capacity. Prismatic, cylindrical, pouch or other configurations may be used, depending on the integration and performance requirements of the module.

The battery cells may be designed to interface effectively with the pressurizing material to maintain interfacial contact and optimize electrochemical performance. The choice of materials and structure may consider factors such as ionic conductivity, mechanical integrity, and stability under operating conditions.

Various solid-state battery chemistries and configurations may be used to achieve specific energy storage characteristics, power output, and operational stability. The selection and arrangement of the battery cells within the module may be adapted for different applications, ensuring compatibility with system requirements and environmental conditions.

### Pressurizing Material

The pressurizing material within the hermetically sealed solid-state battery module applies and maintains isostatic pressure on the battery cells. This pressure management helps sustain interfacial contact, mitigates mechanical stress, and prevents structural degradation over the module's operational lifespan. The pressurizing material may take different forms, including gas-generating compounds, physical blowing agents, or expandable materials, each providing a controlled means of applying force within the hermetically sealed enclosure. The selection of pressurizing material may depend on factors such as compatibility with the battery cells, long-term stability, and the ability to maintain uniform pressure under varying conditions.

### Gas Generating Compounds

Gas-generating compounds are materials that release pressurizing gases within the hermetically sealed enclosure upon activation. These compounds enable controlled pressure generation, maintaining isostatic force on the solid-state battery cells while preventing excessive buildup. Activation of these compounds may occur through thermal decomposition, electrochemical reactions, or chemical activation triggered by environmental conditions. The generated gas may be inert or reactive, depending on the specific battery chemistry and pressurization requirements.

Gas-generating compounds may be selected based on their decomposition characteristics, activation thresholds, and gas production rates. Various classes of compounds may be used, including metal azides, carbonates, hydrides, peroxides, and organic gas-forming agents. The compounds may be stored in solid, liquid, or encapsulated form to ensure controlled and predictable gas release.

In certain embodiments, the gas-generating compound and/or gas-generating system may comprise one or more compounds selected based on functional groups or reactive species capable of generating gas upon activation. For example, the gas-generating compound may comprise: (a) an organic compound comprising a nitrogen-containing functional group selected from azide (—N₃), amine (—NH₂), diazo (—N₂⁺ or R₂CN₂), azo (R—N═N—R′), nitro (—NO₂), nitrate ester, or hydrazine derivatives (—NH—NH₂); (b) an inorganic nitrogen-containing compound selected from ammonium-containing compounds, nitrite-containing compounds, azides, hydrazine, sulfamic acid, or salts thereof; (c) an inorganic carbonate or bicarbonate compound comprising carbonate (CO₃²⁻) or bicarbonate (HCO₃⁻) ; and/or (d) an organic compound capable of decarboxylation or decomposition to release gas, including β-keto acids, isocyanate (R—N═C═O), or oxalate salts. In some embodiments, gas generation further involves one or more additional reagents selected from: (e) one or more additional reagents configured to react with the gas-generating compound or otherwise participate in a gas-generating reaction, including water, acids, oxidants, peroxides, catalysts, phosphines, thermal initiators, or nitrite sources. In some embodiments, the gas-generating compound comprises a single compound. In other embodiments, gas generation may result from a reaction between two or more compounds or components provided in mixed or separated form within the enclosure. In certain embodiments, the gas-generating compound and/or system is selected such that activation results in generation of nitrogen gas (N₂) and/or carbon dioxide (CO₂). The gas-generating compound may be defined by its functional group, ionic composition, reaction mechanism, or gas output, rather than by specific chemical identity.

In certain embodiments, the pressurizing material comprises a single gas-generating compound or a gas-generating system comprising two or more compounds. In other embodiments, the pressurizing material comprises two or more gas-generating compounds. The two or more gas-generating compounds may be provided in a mixed form or may be maintained in separated form within the hermetically sealed enclosure. When maintained in separated form, the gas-generating compounds may be positioned in different regions, layers, or compartments of the enclosure to provide controlled or staged gas generation.

### Thermally Activated Gas-Generating Compounds

Some compounds decompose at specific temperatures to release gas. These compounds may be designed to activate during module assembly, operation, or in response to environmental temperature changes. Examples include:
Sodium azide (NaN₃)—Decomposes at elevated temperatures to produce nitrogen gas (N₂), commonly used in gas inflation systems.
Ammonium bicarbonate (NH₄HCO₃)—Decomposes into ammonia (NH₃), carbon dioxide (CO₂), and water (H₂O) at moderate temperatures.
Calcium carbonate (CaCO₃)—Releases carbon dioxide (CO₂) when heated, commonly used in controlled gas-release applications.
Barium azide (Ba(N₃)₂)—A less common azide that decomposes to release nitrogen gas under thermal activation.
Peroxides (e.g., benzoyl peroxide, hydrogen peroxide solid complexes)—Decomposes to release oxygen gas (O₂) upon thermal stimulation.

### Electrically Activated Gas-Generating Compounds

Some compounds release gas upon exposure to an electrical current or voltage, allowing controlled activation at desired times. Examples include:
Lithium hydride (LiH) or lithium aluminum hydride (LiAlH₄)—Reacts with moisture or controlled electrical activation to produce hydrogen gas (H₂).
Metal hydroxides (e.g., NaOH, KOH) with aluminum—Generates hydrogen gas (H₂) when exposed to electrical currents in the presence of water vapor.
Electrolysis-based gas generators—Certain battery-compatible electrolytes may be used to generate oxygen (O₂) or hydrogen (H₂) through controlled electrolysis upon voltage application.

In certain embodiments, gas generation may occur through interaction between two or more components, such as an acid-base reaction, redox reaction, catalytic decomposition, or thermally initiated reaction. For example, a carbonate or bicarbonate compound may react with an acid to generate carbon dioxide, or a nitrogen-containing compound may decompose or react to generate nitrogen gas.

### Chemically Activated Gas-Generating Compounds

Some compounds produce gas when exposed to specific chemical triggers or reactants within the battery module environment. These reactions may be designed to occur upon module sealing, during operation, or in response to specific conditions such as battery swelling or temperature changes. Examples include:
Carbohydrazide (CH₆N₄O) and derivatives—Releases nitrogen gas (N₂) upon reacting with oxidizing agents.
Azodicarbonamide (C₂H₄O₂N₄)—Produces nitrogen gas (N₂), carbon monoxide (CO), and ammonia (NH₃) when exposed to heat or acids.
Diazo compounds (e.g., diazodiphenylmethane, azobisisobutyronitrile)—Generate nitrogen gas (N₂) upon thermal or chemical activation.
Hydrogen peroxide (H₂O₂) with catalysts (e.g., manganese dioxide, silver oxide)—Releases oxygen gas (O₂) when decomposed by a catalytic reaction.
Carbonates and acids (e.g., sodium bicarbonate with citric acid)—Produces carbon dioxide (CO₂) upon reaction.

### Encapsulated or Delayed-Release Gas Generators

To ensure gradual gas release, gas-generating compounds may be encapsulated within a polymer matrix, gel structure, or controlled-release barrier. Encapsulation allows activation to be delayed until specific conditions are met. Examples include:
Polymer-encapsulated sodium azide—Releases nitrogen gas (N₂) when the polymer degrades at a specific temperature.
Microsphere gas generators—Expand upon heat exposure, triggering gas release from embedded compounds.
Hydride-based microcapsules—Slowly release hydrogen (H₂) in response to moisture or temperature changes.

### Gas Selection and Compatibility

The type of gas released depends on the compound used and its compatibility with the battery module. Inert gases such as nitrogen (N₂), argon (Ar), or carbon dioxide (CO₂) may be preferred to maintain a stable pressurizing environment without unwanted chemical interactions. In some designs, reactive gases such as oxygen (O₂) or hydrogen (H₂) may be used if they contribute to secondary functions within the module.

The selection of gas-generating compounds depends on multiple factors, including activation control, pressure regulation, compatibility with battery materials, and long-term stability. These compounds may be incorporated in different configurations, such as discrete pellets, coatings, or reactive layers, to achieve precise gas-release behavior within the sealed enclosure.

### Physical Blowing Agents

In some embodiments, the pressurizing material comprises one or more physical blowing agents. Physical blowing agents are materials that generate pressurizing gas through phase change, volatilization, or expansion without requiring chemical decomposition. For example, physical blowing agents may include liquefied gases, compressed gases, or low-boiling-point fluids that vaporize upon exposure to temperature increase, pressure reduction, or other activation conditions within the hermetically sealed enclosure. Representative physical blowing agents may include hydrocarbons, fluorocarbons, hydrofluorocarbons (HFCs), carbon dioxide (CO₂), nitrogen (N₂), or other volatile fluids. The use of physical blowing agents may enable controlled pressurization with reduced chemical byproducts and may be selected based on compatibility with the battery cells and enclosure materials.

In certain embodiments, the physical blowing agent may be selected from specific classes of volatile compounds or compressed gases capable of generating pressure through phase change, expansion, or depressurization. For example, the physical blowing agent may comprise: (a) one or more hydrocarbons, including alkanes such as n-pentane, isopentane (2-methylbutane), cyclopentane, n-butane, hexane, or mixtures thereof; (b) one or more hydrofluorocarbons (HFCs), including HFC-245fa, HFC-365mfc, HFC-134a, HFC-227ea, or mixtures thereof; (c) one or more hydrochlorofluorocarbons (HCFCs), including HCFC-141b, HCFC-142b, HCFC-22, or mixtures thereof; (d) one or more hydrofluoroolefins (HFOs) and/or hydrochlorofluoroolefins (HCFOs), including HFO-1336mzz(Z), HCFO-1233zd(E), or isomers or mixtures thereof; and/or (e) one or more compressed, liquefied, or supercritical gases, including carbon dioxide (CO₂), nitrogen (N₂), argon (Ar), or combinations thereof.

In some embodiments, the physical blowing agent may be provided as a single component or as a mixture of two or more components, and may be selected based on volatility, expansion characteristics, compatibility with battery materials, and desired pressure-generation profile within the hermetically sealed enclosure.

### Expandable Materials

Expandable materials apply mechanical pressure by increasing in volume after the solid-state battery module is sealed. These materials expand in a controlled manner to exert uniform isostatic pressure on the battery cells, ensuring stable interfacial contact and mitigating mechanical stress. Expansion may be triggered by heat, chemical reactions, or other environmental conditions. The selection of expandable material depends on factors such as expansion characteristics, pressure distribution properties, compatibility with the enclosure, and long-term stability under operating conditions.

### Foamable Polymers

Foamable polymers expand when activated, filling available space and applying pressure within the hermetically sealed enclosure. These materials typically contain chemical foaming agents or expandable microstructures that increase their volume upon exposure to specific stimuli.

### Thermally Expanding Polymers

These materials undergo expansion when exposed to elevated temperatures, making them suitable for applications where heat activation is integrated into the sealing or operational process. Examples include:
Polyurethane foams—Expand when heated, forming a flexible but compressive structure.
Polyimide foams—High-temperature-resistant materials that maintain structural integrity while expanding.
Expandable thermoplastics (e.g., polypropylene, polyethylene-based beads)—Contain gas-filled microcapsules that expand under heat exposure.

### Chemically Expanding Polymers

These materials expand through chemical reactions that generate gases within the polymer matrix, leading to volumetric growth. Examples include:
Azodicarbonamide-based foaming agents—Decompose into nitrogen (N₂) and carbon dioxide (CO₂), expanding the polymer structure.
Sulfonyl hydrazides (e.g., p-toluenesulfonyl hydrazide)—Generate gas within polymers when chemically triggered.
Expandable epoxy resins—Cure and expand simultaneously, forming rigid or semi-rigid structures.

### Moisture-Activated Polymers

Some materials expand by absorbing moisture from the environment, making them suitable for gradual expansion in sealed enclosures. Examples include:
Hydrophilic polyurethanes—Expand as they absorb water vapor, increasing their volume.
Siloxane-based foams—Chemically stable and moisture-activated to expand under controlled conditions.

### Elastomeric Expandable Materials

Elastomeric materials expand upon activation while maintaining flexibility and controlled pressure application. These materials do not undergo permanent foaming but instead swell or expand to exert force.

### Thermally Expanding Elastomers

These elastomers expand in response to heat, providing mechanical pressure without degrading their elasticity. Examples include:
Silicone elastomers—Expand upon heating while remaining chemically inert.
Fluoroelastomers (e.g., Viton®)—Expand under elevated temperatures while maintaining compressive properties.

### Swelling Elastomers

Swelling elastomers absorb external stimuli (e.g., heat, solvents, or moisture) and increase in volume. Examples include:
Polyolefin-based swelling materials—Expand when exposed to hydrocarbon-based environments.
Hydrogel elastomers—Increase in size upon moisture absorption.

### Expandable Composites

Certain composite materials are engineered to expand volumetrically through phase changes or internal structural shifts. These materials provide a stable expansion profile and controlled force distribution.

### Phase-Change Polymers

Some materials undergo reversible phase transitions, expanding as they shift from one state to another. Examples include:
Solid-to-gel expansion materials—Initially rigid but swell into a gel-like form upon activation.
Liquid-crystal elastomers—Change shape when exposed to thermal or electromagnetic stimuli.

### Encapsulated Expansion Materials

Encapsulation allows controlled expansion by releasing gas or swelling agents within a composite matrix. Examples include:
Microsphere-filled polymers—Tiny expandable beads embedded in a matrix expand when activated.
Encapsulated gas-generating particles—Distribute pressure evenly by expanding within a polymer framework.

### Selection Considerations

The choice of expandable material depends on various factors, including:
Activation method—Thermal, chemical, moisture-based expansion.
Expansion rate—Gradual or rapid volumetric increase.
Mechanical stability—Ability to sustain pressure without degradation.
Compatibility—Interaction with battery cells, enclosure materials, and environmental conditions.

Expandable materials provide a reliable method for maintaining pressure within the sealed battery module, ensuring consistent force application while remaining adaptable to varying operating conditions.

### Electrical Connections

The electrical connections within the solid-state battery module provide conductive pathways for energy transfer. These connections enable efficient current flow between the battery cells and external circuits while ensuring mechanical stability and reliability. The enclosure incorporates electrical feedthroughs that allow these connections to extend through its structure, enabling external electrical interfacing without compromising the module's overall configuration.

The internal electrical interconnections are configured to facilitate the efficient transfer of energy between battery cells and the module's external terminals. These connections may include busbars, tab welds, wire bonds, or flexible conductors, depending on the module design. Busbars provide low-resistance pathways for high-current applications, while tab welds and wire bonds are well-suited for compact configurations requiring precision and mechanical flexibility. Flexible conductors may be used to accommodate relative movement between interconnected components while maintaining electrical continuity.

The arrangement of electrical pathways within the enclosure is designed to minimize resistance, heat generation, and voltage drops while maintaining uniform current distribution across the battery cells. The interconnection layout may vary depending on the module's configuration, supporting serial, parallel, or hybrid arrangements to achieve the desired voltage and capacity. To enhance performance, the internal electrical network may incorporate layered or stacked interconnect structures that optimize space utilization while ensuring reliable connectivity.

The electrical feedthroughs extend the battery module's internal connections to external circuits while passing through the enclosure. These feedthroughs may take various forms, including hermetically sealed terminals, embedded conductive vias, or insulated pin connections that allow electrical contact while integrating into the enclosure's structural design. The geometry and placement of the feedthroughs are configured to support electrical performance while accommodating mechanical and thermal stresses during operation.

To enhance durability and long-term reliability, the feedthroughs may include reinforced interfaces that provide mechanical support to prevent stress concentrations at the connection points. Structural reinforcements such as rigid mounting bases, encapsulated conductors, or compliant regions can be incorporated to mitigate mechanical strain caused by thermal expansion, vibration, or external forces.

The connection points between internal interconnects and external terminals may incorporate various attachment methods such as welding, soldering, compression fittings, or conductive adhesives. The selection of attachment methods depends on factors such as electrical resistance, thermal compatibility, and mechanical robustness. For configurations requiring modular or removable connections, plug-in terminals or spring-loaded contacts may be used to facilitate assembly and serviceability.

The design of the electrical connections considers factors such as electrical insulation, thermal management, and mechanical protection. Insulating barriers or dielectric coatings may be applied to prevent unintended electrical contact and manage potential electrical arcing or leakage currents. For high-power applications, the connections may be designed to dissipate heat efficiently, incorporating features such as heat sinks, thermally conductive pathways, or integrated cooling elements to prevent localized overheating and ensure stable operation.

By integrating robust electrical pathways, strategically designed feedthroughs, and durable attachment mechanisms, the electrical connections within the solid-state battery module provide reliable and efficient energy transfer while maintaining structural integrity and adaptability to varying operational conditions.

Generally, a hermetically sealed solid-state battery module may have two feedthroughs for the flow of electrical current to and from the solid-state battery cells and external circuit. However, a hermetically sealed solid-state battery module may have more than two feedthroughs for the flow of electrical current to, for example, sensors, monitors, heaters, or means to activate the gas-generating compounds. In another example, additional feedthroughs may be used to flow electrical current to the solid-state battery cells for resistive or inductive heating purposes. In yet another example, additional feedthroughs may be used to flow an electromagnetic wave to the solid-state battery cell for dielectric heating.

### Method for Manfacturing the Solid State Battery

The manufacturing method for the solid-state battery module involves assembling the necessary components to form a sealed, pressurized energy storage system. The process includes placing the solid-state battery cells within an enclosure, incorporating a pressurizing material, and sealing the enclosure to maintain a controlled internal environment. Electrical connections are integrated to enable energy transfer while ensuring compatibility with the sealed structure.

### Placement of Solid-State Battery Cells

The battery cells are positioned within the enclosure in a configuration that optimizes electrical performance, mechanical stability, and thermal management. The arrangement may vary depending on factors such as module size, voltage and capacity requirements, and the specific characteristics of the solid-state electrolyte. Cells may be stacked, arranged in layers, wound, or otherwise structured to achieve the desired electrical and mechanical properties. The placement process may involve alignment guides, separators, or structural supports to ensure the cells remain secure and properly oriented within the enclosure.

### Incorporation of Pressurizing Material

A pressurizing material is included within the enclosure to apply isostatic pressure to the battery cells. The method of introducing the pressurizing material depends on its composition and activation mechanism. The material may be pre-formed, deposited, or introduced as a reactive or expandable substance that activates after sealing. It may be freely positioned, embedded in a structure, or contained within compartments designed to regulate its expansion or gas release. If the pressurizing material requires activation, the module may incorporate features or mechanisms to initiate the process through thermal, chemical, electrical, or mechanical triggers. The amount and distribution of the pressurizing material are configured to ensure uniform pressure application across the battery cells, maintaining stable interfacial contact throughout the module's operational lifespan.

### Sealing the Enclosure

Once the battery cells and pressurizing material are in place, the enclosure is hermetically sealed to prevent gas ingress or egress and maintain internal pressure. The sealing method depends on the enclosure's design, materials, and intended application. Welding or brazing may be used to create a permanent, high-strength seal that resists thermal and mechanical stresses. Bonding or adhesive sealing may be applied to establish a durable connection while accommodating flexibility in material selection. In some configurations, gasketed or compression sealing may be employed, particularly when modular access is required (such as solid-state battery cell replacement) while maintaining airtight integrity. The enclosure may include integrated sealing surfaces, interlocking edges, or precision-machined joints to facilitate proper sealing. In certain designs, additional reinforcements or multiple sealing layers may be incorporated to improve long-term reliability.

### Integration of Electrical Connections

Electrical connections are established within the module to enable energy transfer while extending through the enclosure via electrical feedthroughs. The connections may involve busbars, tab welds, wire bonds, or flexible conductors that interface with the battery cells. The feedthroughs are positioned to extend through the enclosure while maintaining mechanical and electrical integrity. Connection points may be welded, soldered, bonded, or secured using mechanical fasteners depending on design requirements. The electrical configuration is optimized to minimize resistance, manage thermal effects, and ensure mechanical durability over the module's lifespan. Insulating barriers, protective coatings, or reinforcement structures may be included to enhance electrical performance and reliability. It is preferred that the electrical feedthroughs are integrated into the enclosure before placement of the solid-state battery cells so that all electrical connections within the enclosure are connected before sealing.

### Final Assembly Considerations

Following the sealing and electrical integration steps, the module may undergo additional assembly processes, such as the installation of external connection terminals, protective casings, or supporting hardware for integration into a larger system. Depending on the application, the manufacturing method may also accommodate variations in component placement, material selection, and assembly techniques to meet specific performance and reliability requirements.

### Method for Operating the Solid State Battery

The method for operating the solid-state battery module involves providing a hermetically sealed enclosure containing one or more solid-state battery cells and a pressurizing material. The module is designed to maintain a controlled internal environment, ensuring that the battery cells operate under optimal pressure conditions to sustain electrochemical efficiency and mechanical stability throughout their operational lifespan.

During operation, the pressurizing material applies isostatic pressure to the battery cells, which helps maintain stable interfacial contact, minimizes resistance at material boundaries, and prevents structural degradation such as delamination, void formation, or cracking. The pressurizing material may function passively by exerting continuous pressure within the sealed enclosure, or it may require activation through thermal, chemical, electrical, or mechanical stimuli to achieve the desired pressure conditions. Activation may occur upon initial deployment of the module or in response to specific operational triggers designed to maintain or regulate internal pressure over time.

The solid-state battery cells function as energy storage and delivery components, discharging and recharging according to system demands. Their electrochemical performance is influenced by factors such as internal pressure stability, thermal conditions, and mechanical integrity. The module may be designed to interface with external control systems that monitor operational parameters and adjust conditions as necessary to support reliable performance.

Throughout operation, the hermetically sealed enclosure preserves the integrity of the internal environment by preventing gas ingress or egress and ensuring consistent pressurization. The structure of the enclosure is engineered to withstand thermal expansion, mechanical stresses, and variations in pressure, maintaining a stable operating environment for the battery cells. The electrical feedthroughs allow for energy transfer while maintaining the enclosure's integrity, ensuring that the battery module can be safely integrated into larger systems.

The operational method may also accommodate variations in pressurization dynamics, including gradual adjustments to maintain stable pressure conditions over the module's lifespan. The system may be designed to function in a passive or active mode, where pressurization is either sustained continuously or adjusted dynamically in response to changes in environmental or operational conditions.

By maintaining controlled pressurization and a stable electrochemical environment, the solid-state battery module operates efficiently while minimizing degradation, enhancing energy output, and ensuring long-term reliability for applications in electric vehicles, aerospace, consumer electronics, grid storage, and other energy-intensive systems.

### Amount of Pressurizing Material

The amount of pressurizing material in the solid-state battery module can be determined based on the internal free volume, the initial pressure conditions upon sealing, and the desired final pressure necessary to maintain isostatic compression on the battery cells. The pressurizing material may be provided in a quantity sufficient to achieve and sustain this target pressure while accounting for variations in temperature, battery cell expansion or contraction, and potential material changes over time.

### Initial Conditions and Free Volume Considerations

Upon sealing, the enclosure may contain an initial volume of gas, typically at atmospheric pressure. The free volume within the sealed enclosure includes the internal space not occupied by the battery cells, structural components, or the pressurizing material itself. This volume can establish the baseline pressure conditions before activation or expansion of the pressurizing material.

The relationship between free volume and pressurizing material capacity may be considered when determining how much material is used to reach the intended final pressure. The free volume can be estimated based on the physical dimensions of the enclosure and the space occupied by its internal components.

### Pressurizing Material and Pressure Generation

The pressurizing material may generate pressure through gas release, volume expansion, or phase change. The amount required can depend on its specific pressurization mechanism.

For gas-generating compounds, the total pressure increase may be estimated using the ideal gas law: PV=nRT, wherein:
P is the final pressure in the enclosure,
V is the free volume,
n is the number of moles of gas produced,
R is the universal gas constant, and
T is the absolute temperature.

From this relationship, the quantity of gas-generating material may be calculated by determining the number of moles of gas needed to achieve the desired pressure increase. The characteristics of the material may define the amount of gas it can generate per unit mass or volume.

For expandable materials, the amount may be based on the material's volumetric expansion ratio and compressibility. The pressurizing material can be designed to expand sufficiently to exert uniform pressure across the battery cells without excessive force that could affect cell integrity.

### Achieving the Desired Final Pressure

The final pressure in the enclosure may depend on:
The amount of pressurizing material relative to free volume—A greater amount of material or a material with a higher pressurization capacity may generate more force.
Temperature fluctuations—Changes in operating temperature can affect gas expansion, material properties, and pressure retention.
Potential gas absorption or leakage over time—Although the enclosure is hermetically sealed, long-term stability may be considered in material selection.

The amount of pressurizing material may be selected to provide a sustained and stable pressure that can compensate for minor volume fluctuations in the enclosure over time. In some designs, redundant or excess capacity may be included to ensure pressure remains within the required range despite gradual material consumption or environmental variations.

By considering the free volume, initial pressure, material properties, and final pressure requirements, the amount of pressurizing material can be adjusted to help maintain consistent and reliable performance throughout the operational life of the solid-state battery module.

### Gas Storage and Release Mechanisms

The pressurizing material may be stored and released using various mechanisms to facilitate controlled gas diffusion into the unoccupied volume of the enclosure. In some configurations, a secondary compartment may be included within the enclosure to house the gas-generating material, allowing the generated gas to gradually diffuse into the main volume upon activation. Alternatively, the pressurizing material may be enclosed in a pouch or capsule, which can be positioned within a compartment inside the enclosure. Upon activation, the generated gas may diffuse out of the pouch and into the unoccupied volume to establish and maintain the desired pressure. In another variation, the gas-generating agent may be dispersed within a polymer matrix, where the gas is released into the pores of the polymer and subsequently into any remaining open volume within the enclosure. These mechanisms allow for precise control over gas generation, ensuring that isostatic pressure is applied consistently across the battery cells.

### Additional Terminal Ports Beyond Electrical Feedthroughs

In addition to electrical feedthroughs for power transfer, the enclosure may incorporate additional terminal ports designed to serve a variety of functions. These ports may facilitate external activation of the pressurizing material, allowing for controlled gas release at a designated time during assembly, deployment, or operation. Additional ports may also be included for thermal management, such as integrating heating elements to regulate the battery's temperature or activate a thermally sensitive gas-generating material. Monitoring terminals may provide real-time temperature, pressure, state-of-charge, and state-of-health data, allowing for improved system diagnostics and performance optimization. These terminal ports may be designed to interface with external monitoring and control systems, enhancing the battery module's adaptability across various applications.

### Gas Selection: Inert and Non-Inert Gases

The pressurizing gas generated within the enclosure may include both inert and non-inert gases, depending on the specific application and battery chemistry. Inert gases such as nitrogen (N₂) or argon (Ar) may be used when a chemically stable pressurization environment is required. Alternatively, non-inert gases such as carbon dioxide (CO₂), oxygen (O₂), water vapor (H₂O), methane (CH₄), butane (C₄H₁₀), or chlorine (Cl₂) may be used where specific electrochemical or functional interactions with battery components are desirable. The gas selection may be based on factors such as chemical compatibility with battery materials, long-term stability, desired pressure regulation characteristics, and operational safety requirements.

In certain embodiments, the gas-generating compound is selected such that the generated gas comprises nitrogen (N₂) and/or carbon dioxide (CO₂), which may be preferred due to chemical compatibility and stability within the battery module.

### Defined Free Volume and Pressure Ranges

The free volume within the battery module may be defined as the unoccupied space that remains after the battery cells and structural components are installed. This volume may include gaps between battery cells, space between cells and the enclosure, or designated compartments for gas-generating agents. To optimize pressurization efficiency, the free volume may be minimized, reducing the amount of pressurizing material required to achieve the target pressure. Representative free volume values may range from 0.00001 L to 100 L, with more typical ranges between 0.0001 L and 10 L, depending on module size and configuration. The desired isostatic pressure within the enclosure may range from 1 kPa to 1,000,000 kPa, with preferred values falling between 100 kPa and 10,000 kPa, depending on the specific mechanical and electrochemical requirements of the battery cells. The pressurizing material amount may be determined using the ideal gas law (PV=nRT), ensuring that the final pressure remains within the optimal range for stable battery operation.

### Sealing and Pressure Stability Over Temperature Ranges

The sealed enclosure may be designed to maintain internal pressure stability across a range of environmental and operational temperatures. Since internal pressure may fluctuate with temperature changes, the enclosure can be engineered to withstand thermal expansion and contraction without compromising its structural integrity. The module may be designed to operate within a temperature range of −70° C. to 200° C., ensuring that pressure remains within the intended range under both cold-start conditions and high-temperature environments. The corresponding internal pressure variations at these temperatures may range from 0.75 kPa to 2,000,000 kPa, depending on gas composition and enclosure volume. Structural reinforcements, compliance features, or pressure-regulating elements may be incorporated to ensure stable operation across varying thermal conditions.

### Activation Methods for Gas-Generating Agents

The pressurizing material may be activated through various mechanisms depending on its composition and intended function. Thermal activation may involve heating elements embedded within the module or external heat sources applied during or after sealing. Chemical activation may involve introducing a reactive compound that interacts with the gas-generating agent to produce pressurizing gas. Electrical activation may involve applying a voltage or current to the pressurizing material, triggering an electrochemical reaction that releases gas. These activation mechanisms may be tailored to ensure controlled gas generation, enabling precise timing and distribution of isostatic pressure within the enclosure.

### Expanded Application Areas

The solid-state battery module may be used in a wide range of applications where controlled pressurization enhances battery performance and reliability. In consumer electronics, the module may be incorporated into wristwatches, smartwatches, smartphones, laptops, tablets, and other portable devices requiring compact, high-energy-density storage. In electric mobility, the module may be deployed in electric vehicles, plug-in hybrid electric vehicles, motorcycles, scooters, trains, and maritime vessels to improve safety and longevity under demanding conditions. In aerospace applications, the module may provide a reliable power source for satellites, aircraft, drones, and space exploration vehicles, where pressurization aids in maintaining battery integrity in extreme environments. The module may also be used in grid storage, military, and industrial applications, where long-term durability and operational stability are key considerations.

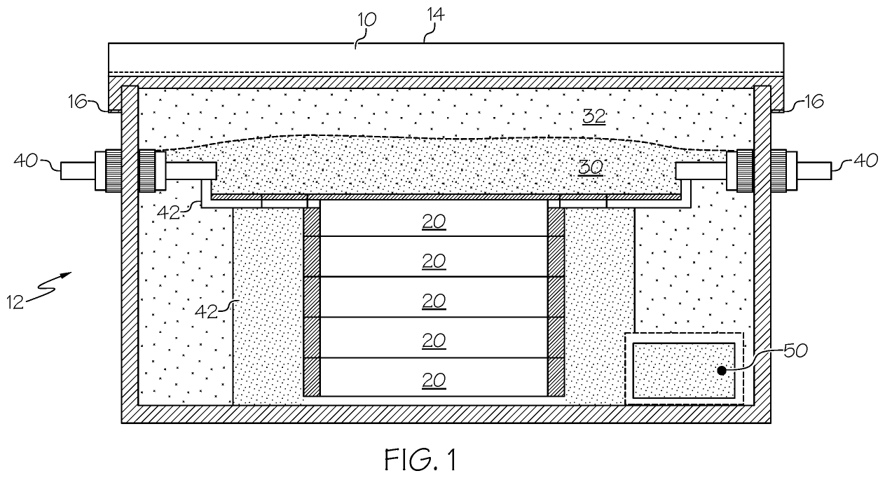

### Detailed Description of FIG. 1

FIG. 1 illustrates a schematic cross-sectional view of an example hermetically sealed solid-state battery module according to certain embodiments of the present disclosure. The battery module includes a hermetically sealed enclosure 10 that defines an internal cavity configured to maintain a controlled internal environment. The enclosure 10 may include a main housing body 12 and a cover plate 14 that are joined at a sealing interface 16. The sealing interface 16 may comprise a welded seam, brazed joint, bonded interface, gasketed seal, or other hermetic sealing structure configured to prevent the ingress or egress of gases and to maintain internal pressure within the enclosure 10.

One or more solid-state battery cells 20 are disposed within the enclosure 10. In the illustrated embodiment, the battery cells 20 are arranged in a stacked configuration; however, other arrangements may be used, including layered, wound, prismatic, cylindrical, or pouch configurations depending on module design requirements. The battery cells 20 may include cathode materials, solid electrolytes, anode structures, and current collectors configured to provide electrochemical energy storage and delivery.

A pressurizing material 30 is positioned within the enclosure 10 and is configured to apply pressure to the battery cells 20. In certain embodiments, the pressurizing material 30 may occupy regions surrounding the battery cells 20, thereby applying substantially uniform or isostatic pressure to the cells. The pressurizing material 30 may comprise a gas, a gas-generating compound, an expandable polymer or elastomer, or other pressure-generating material capable of exerting force on the battery cells 20 within the sealed enclosure 10.

The enclosure 10 may further define an internal free volume 32, which may contain pressurizing gas or otherwise accommodate expansion of the pressurizing material 30. The free volume 32 may facilitate pressure distribution within the enclosure and allow the internal pressure to stabilize as the pressurizing material 30 expands or releases gas.

Electrical feedthroughs 40 extend through walls of the enclosure 10 and provide electrical communication between the battery cells 20 and external circuitry. The feedthroughs 40 may be hermetically sealed conductive terminals that pass through the enclosure wall while maintaining the integrity of the hermetic seal. External terminals may be connected to the feedthroughs 40 to allow electrical connection to external power systems, charging circuits, monitoring electronics, or other electrical devices. Internally, conductive structures such as a busbar 42 may electrically couple the battery cells 20 to the feedthroughs 40.

In some embodiments, the enclosure 10 may further include a gas-generating compartment 50 containing a gas-generating material. The gas-generating compartment 50 may be configured to release gas into the enclosure 10 upon activation of the gas-generating material. The generated gas may diffuse into the internal volume of the enclosure 10, thereby increasing internal pressure and contributing to the isostatic pressurization applied to the battery cells 20.

The configuration illustrated in FIG. 1 represents one example implementation of a hermetically sealed solid-state battery module with internal pressurization. Various modifications to the geometry, component arrangement, pressurizing materials, and electrical connection structures may be employed without departing from the scope of the present disclosure.

Clause 1. A solid-state battery module, comprising: a hermetically sealed enclosure configured to prevent the ingress and egress of gases; one or more solid-state battery cells disposed within the hermetically sealed enclosure; and a pressurizing material positioned within the hermetically sealed enclosure, wherein the pressurizing material is configured to apply isostatic pressure to the one or more solid-state battery cells.

Clause 2. The solid-state battery module of Clause 1, wherein the hermetically sealed enclosure comprises a housing and a cover joined at a sealing interface.

Clause 3. The solid-state battery module of Clause 2, wherein the sealing interface comprises a welded joint, brazed joint, bonded interface, or gasketed seal.

Clause 4. The solid-state battery module of Clause 1, wherein the enclosure defines an internal free volume configured to receive a pressurizing gas generated by the pressurizing material.

Clause 5. The solid-state battery module of Clause 1, wherein the pressurizing material comprises at least one of a gas-generating compound and a physical blowing agent.

Clause 6. The solid-state battery module of Clause 5, wherein the gas-generating compound comprises a gas-generating compound selected from the group consisting of:
(a) an organic compound containing a nitrogen-rich functional group selected from azide (—N₃), primary amine (—NH₂), diazo (—N₂⁺ or R₂C₂2), azo (R—N═N—R′, where R and R′ may be identical or different) nitro (—NO₂), nitrate ester, or hydrazine derivative (—NH—NH₂);
(b) an inorganic nitrogen compound selected from ammonium ion (NH₄⁺) , nitrite ion (NO₂⁻), ammonium nitrite (NH₄NO₂), azide ion (N₃⁻), sulfamic acid (NH₂SO₃H), hydrazine (N₂H₄), or salts thereof;
(c) an inorganic carbonate or bicarbonate compound containing carbonate ion (CO₃²⁻) or bicarbonate ion (HCO₃⁻); or
(d) an organic compound selected from β-keto acid (—C(O)CH₂COOH), isocyanate (R—N═C═O), or oxalate (C₂O₄²⁻) salts; and
optionally (e) an additional reagent selected from water, an acid, peroxide, oxidant, phosphine, transition metal catalyst, thermal initiator, or nitrite source, wherein the reaction releases N₂ or CO₂ gas.

Clause 7. The solid-state battery module of Clause 5, wherein the physical blowing agent comprises a physical blowing agent selected from the group consisting of compressed hydrocarbons, hydrofluorocarbons (HFCs), hydrochlorofluorocarbons (HCFCs), hydrofluoroolefins (HFOs), hydrochlorofluoroolefins (HCFOs), or compressed, liquefied or supercritical gases.

Clause 8. The solid-state battery module of Clause 1, wherein the pressurizing material comprises an expandable material configured to expand after sealing of the enclosure.

Clause 9. The solid-state battery module of Clause 8, wherein the expandable material comprises a foamable polymer, elastomeric expansion material, or expandable composite.

Clause 10. The solid-state battery module of Clause 1, further comprising at least one electrical feedthrough extending through the hermetically sealed enclosure and electrically coupled to the one or more solid-state battery cells.

Clause 11. A method for manufacturing a solid-state battery module, comprising: placing one or more solid-state battery cells within an enclosure; positioning a pressurizing material within the enclosure; and hermetically sealing the enclosure to create a hermetically sealed solid-state battery module.

Clause 12. The method of Clause 11, further comprising electrically connecting the one or more solid-state battery cells to at least one electrical feedthrough extending through the enclosure.

Clause 13. The method of Clause 11, wherein positioning the pressurizing material comprises placing a gas-generating compound within the enclosure.

Clause 14. The method of Clause 11, wherein positioning the pressurizing material comprises placing an expandable polymer material within the enclosure.

Clause 15. The method of Clause 11, wherein hermetically sealing the enclosure comprises welding, brazing, bonding, or compression sealing the enclosure.

Clause 16. A method for operating a solid-state battery module, comprising: providing a hermetically sealed solid-state battery module comprising: one or more solid-state battery cells; and a pressurizing material within a hermetically sealed enclosure; and activating the pressurizing material to apply isostatic pressure to the one or more solid-state battery cells.

Clause 17. The method of Clause 16, wherein activating the pressurizing material comprises thermally, electrically, physically, or chemically activating a gas-generating compound, a mixture of two or more gas-generating compounds, or a physical blowing agent.

Clause 18. The method of Clause 16, wherein activating the pressurizing material comprises physically releasing physical blowing agents.

Clause 19. The method of Clause 16, wherein the pressurizing material generates a pressurizing gas within a free volume of the hermetically sealed enclosure.

Clause 20. The method of Clause 16, wherein the pressurizing material expands within the enclosure to apply isostatic pressure to the one or more solid-state battery cells.

Although various embodiments of the disclosed systems and methods have been shown and described, modifications may occur to those skilled in the art upon reading the specification. The present application includes such modifications and is limited only by the scope of the claims.

What is claimed is:

1. A solid-state battery module, comprising:
a hermetically sealed enclosure configured to prevent the ingress and egress of gases;
one or more solid-state battery cells disposed within the hermetically sealed enclosure; and
a pressurizing material positioned within the hermetically sealed enclosure, wherein the pressurizing material is configured to apply isostatic pressure to the one or more solid-state battery cells.

2. The solid-state battery module of claim 1, wherein the hermetically sealed enclosure comprises a housing and a cover joined at a sealing interface.

3. The solid-state battery module of claim 2, wherein the sealing interface comprises a welded joint, brazed joint, bonded interface, or gasketed seal.

4. The solid-state battery module of claim 1, wherein the enclosure defines an internal free volume configured to receive a pressurizing gas generated by the pressurizing material.

5. The solid-state battery module of claim 1, wherein the pressurizing material comprises at least one of a gas-generating compound and a physical blowing agent.

6. The solid-state battery module of claim 5, wherein the gas-generating compound comprises a gas-generating compound selected from the group consisting of:
(a) an organic compound containing a nitrogen-rich functional group selected from azide (—N₃), primary amine (—NH₂), diazo (—N₂⁺ or R₂CN₂), azo (R—N═N—R′, where R and R′ may be identical or different) nitro (—NO₂), nitrate ester, or hydrazine derivative (—NH—NH₂);
(b) an inorganic nitrogen compound selected from ammonium ion (NH₄⁺), nitrite ion (NO₂⁻), ammonium nitrite (NH₄NO₂), azide ion (N₃⁻), sulfamic acid (NH₂SO₃H), hydrazine (N₂H₄), or salts thereof;
(c) an inorganic carbonate or bicarbonate compound containing carbonate ion (CO₃²⁻) or bicarbonate ion (HCO₃⁻); or
(d) an organic compound selected from β-keto acid (—C(O)CH₂COOH), isocyanate (R—N═C═O), or oxalate (C₂O₄²⁻) salts; and
optionally (e) an additional reagent selected from water, an acid, peroxide, oxidant, phosphine, transition metal catalyst, thermal initiator, or nitrite source, wherein the reaction releases N₂ or CO₂ gas.

7. The solid-state battery module of claim 5, wherein the physical blowing agent comprises a physical blowing agent selected from the group consisting of compressed hydrocarbons, hydrofluorocarbons (HFCs), hydrochlorofluorocarbons (HCFCs), hydrofluoroolefins (HFOs), hydrochlorofluoroolefins (HCFOs), or compressed, liquefied or supercritical gases.

8. The solid-state battery module of claim 1, wherein the pressurizing material comprises an expandable material configured to expand after sealing of the enclosure.

9. The solid-state battery module of claim 8, wherein the expandable material comprises a foamable polymer, elastomeric expansion material, or expandable composite.

10. The solid-state battery module of claim 1, further comprising at least one electrical feedthrough extending through the hermetically sealed enclosure and electrically coupled to the one or more solid-state battery cells.

11. A method for manufacturing a solid-state battery module, comprising:
placing one or more solid-state battery cells within an enclosure;
positioning a pressurizing material within the enclosure; and
hermetically sealing the enclosure to create a hermetically sealed solid-state battery module.

12. The method of claim 11, further comprising electrically connecting the one or more solid-state battery cells to at least one electrical feedthrough extending through the enclosure.

13. The method of claim 11, wherein positioning the pressurizing material comprises placing a gas-generating compound within the enclosure.

14. The method of claim 11, wherein positioning the pressurizing material comprises placing an expandable polymer material within the enclosure.

15. The method of claim 11, wherein hermetically sealing the enclosure comprises welding, brazing, bonding, or compression sealing the enclosure.

16. A method for operating a solid-state battery module, comprising:
providing a hermetically sealed solid-state battery module comprising:
one or more solid-state battery cells; and
a pressurizing material within a hermetically sealed enclosure; and
activating the pressurizing material to apply isostatic pressure to the one or more solid-state battery cells.

17. The method of claim 16, wherein activating the pressurizing material comprises thermally, electrically, physically, or chemically activating a gas-generating compound, a mixture of two or more gas-generating compounds, or a physical blowing agent.

18. The method of claim 16, wherein activating the pressurizing material comprises physically releasing physical blowing agents.

19. The method of claim 16, wherein the pressurizing material generates a pressurizing gas within a free volume of the hermetically sealed enclosure.

20. The method of claim 16, wherein the pressurizing material expands within the enclosure to apply isostatic pressure to the one or more solid-state battery cells.
